(19) United States
(12) Patent Application Publication
(10) Pub. No.: US 2009/0208060 A1
(43) Pub. Date: Aug. 20, 2009

(54) LICENSE PLATE RECOGNITION SYSTEM USING SPATIAL-TEMPORAL SEARCH-SPACE REDUCTION AND METHOD THEREOF

(76) Inventors: Shen-Zheng Wang, Taoyuan City (TW); Hsi-Jian Lee, Hualien City (TW)

Correspondence Address: SINORICA, LLC, 2275 Research Blvd., Suite 500, ROCKVILLE, MD, 20850, US

(21) Appl. No.: 12/107,882

(22) Filed: Apr. 23, 2008

(30) Foreign Application Priority Data
Feb. 18, 2008 (TW) 97105626

(51) Int. Cl. G06K 9/00

(52) U.S. Cl. 382/105

(57) ABSTRACT

The present invention discloses a license plate recognition system by utilizing spatial-temporal search-space reduction and method thereof. The license plate recognition system can selects a pixel with character edge feature from the inputted image and a plurality of candidate regions from the image; and detect if the candidate region of the inputted image has been appeared in a preceding image. Then the recognition system in the present invention separates the candidate region into a plurality of blocks, calculates the repeated block based on a current image and a preceding image, and determines whether the candidate region is repeated according to the repeated block. Thus, by discarding the repeated regions, the license plate recognition system in the present invention can avoid redundant calculation and improve the efficiency and performance for recognition of real plate character in the image.

### BACKGROUND OF THE INVENTION

1. Field of the Invention

The invention relates to a video image analysis technology, and more particularly, to a license plate recognition system by utilizing spatial-temporal search-space reduction and method thereof.

2. Description of the Related Art

With the accelerated development of economy and technology, vehicles not only play as the means of transportation but also as a sense of identity. However, how to supervise and reduce the vehicles problems effectively, such as traffic accidents and vehicle burglary, are of utmost importance during the past two decades. The present surveillance control of vehicles, such as the high-speed photo detector, or the police patrol, requires a great quantity of manpower. Therefore, using the automatic plate recognition system to cooperate with the above-mentioned work for reducing manpower is coming with the tide of fashion.

However, for the application of plate recognition system, different locations would cause different images. For example, the environment of illumination or plate-like backgrounds, or the plate locations, amounts, sizes, types, colors, even the frames and screws on the plates, would increase the difficulty of plate recognition. Moreover, the conventional plate recognition system can only deal with a plate image once at a time, and is limited by distinguishing the character area from the non-character area in the image. That is, the traditional plate recognition system remains a major challenge in dealing with multiple plate images simultaneously and performing the real-time calculation. Therefore, how to generate the plate recognition system with excellent recognition rate and high-speed calculation is the key issue for vehicle industry.

Therefore, to solve the above-mentioned problems, the present invention proposes a novel license plate recognition system by utilizing spatial-temporal search-space reduction and method thereof to improve the efficiency and performance for recognizing a series of inputted images of license plates.

### SUMMARY OF THE INVENTION

It is therefore one of the many objectives of the claimed invention to provide a novel license plate recognition method by rapidly searching candidate regions from the inputted image to improve the efficiency of operation.

Another objective of the claimed invention is to provide a license plate recognition method by searching the plate character candidate region based on spatial search-space reduction to avoid redundant calculation of non-plate-character region.

Another objective of the claimed invention is to provide a license plate recognition method by searching the repeated region based on temporal search-space reduction. If the captured scene in the image is still, which means the consecutive images have similar appearances, the candidate regions will have the same or similar classification results. Thus, discarding the repeated candidate regions can avoid redundant calculation and save significantly amount and time of calculation.

Another objective of the claimed invention is to provide a license plate recognition method by utilizing spatial-temporal search-space reduction to improve the efficiency and performance for recognition of real plate character in the consecutive images.

According to the claimed invention, a license plate recognition method by utilizing spatial-temporal search-space reduction is disclosed. The license plate recognition method includes: capturing a plurality of candidate regions from an inputted image, and placing the candidate regions in a candidate area; detecting whether the candidate region of a current image has been appeared on at least a preceding image, if yes, then discarding the candidate region from the candidate area; and outputting the candidate region from the candidate area.

Also according to the claimed invention, a license plate recognition system by utilizing spatial-temporal search-space reduction is disclosed. The license plate recognition system includes: a character edge region detecting module for selecting a plurality of pixels with character edge feature from the inputted image; a plate character candidate region detecting module for selecting a plurality of candidate regions from the image, and if the candidate region comprises at least a plate character, the candidate region is defined as the region that bound the top and bottom of the plate characters tightly; and a repeated region detecting module for detecting if the candidate region of the inputted image has been appeared in a preceding image.

Below, the embodiments of the present invention are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a license plate recognition system according to the present invention;

FIGS. 2A and 2B are diagrams schematically showing the conventional plate region and the plate region captured by license plate recognition system of the present invention respectively;

FIG. 3 is a flowchart showing an embodiment of operations of the license plate recognition system according to the present invention;

FIGS. 4, 5A, and 5B are diagrams schematically showing the algorithm of Bi-level one-pass plate extraction (BOPE) in the present invention;

FIG. 6A to 6E are diagrams schematically showing an embodiment of the license plate recognition system according to the present invention; and

FIG. 7A to 7C are diagrams schematically showing an embodiment of performing different feature extractions according to the present invention.

### DETAILED DESCRIPTION OF THE INVENTION

The present invention provides a license plate recognition system by utilizing spatial-temporal search-space reduction and method thereof to improve the efficiency and performance for recognizing a series of inputted images of license plates.

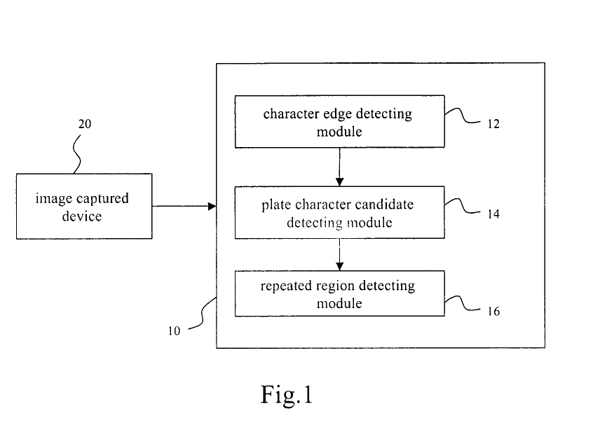

Please refer to FIG. 1. FIG. 1 is a diagram schematically showing a license plate recognition system 10 according to the present invention. The plate recognition system 10 includes a character edge detecting module 12, a plate character candidate detecting module 14, and a repeated region detecting module 16. When at least a image capture device 20 (e.g. a video camera) captures and inputs an image picture into the license plate recognition system 10, the character edge detecting module 12 will detect the region with character edge, and retain that character edge region. The plate character candidate detecting module 14 then selects a plurality of candidate regions from the character edge region. Next, the repeated region detecting module 16 detects the repeated candidate regions and discards them.

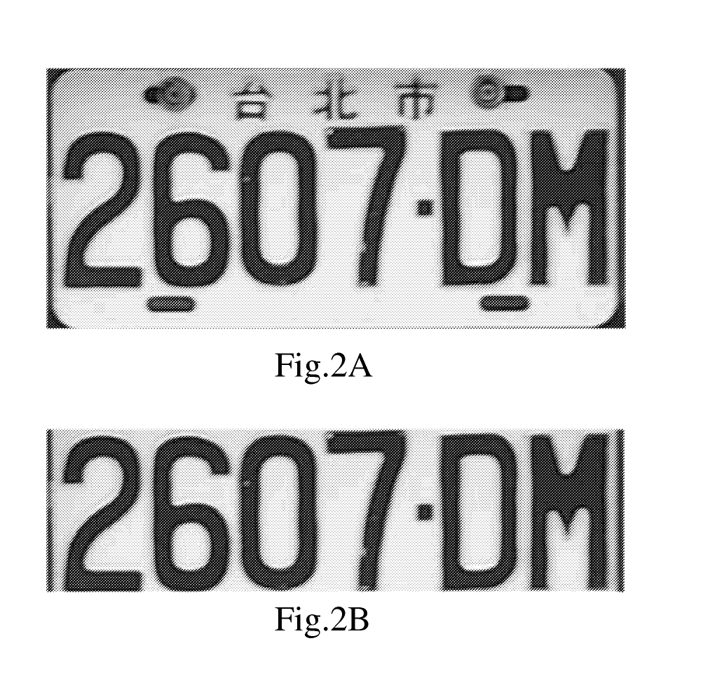

FIG. 2A is a diagram schematically showing the conventional plate region that plate characters and various adornments such as frames, screws, and subtitles. However, in the present invention, the character edge detecting module 12 generates the character edge region by vertical gradients. Then the plate character candidate detecting module 14 utilizes a Bi-level one-pass plate extraction (BOPE) algorithm to extract all candidate regions rapidly. In the present invention, the candidate region is defined as the region that bound the top and bottom of plate characters tightly, as shown in FIG. 2B. By detecting candidate regions only, the license plate recognition system 10 in the present invention can avoid additional procedures for removing the adornment before plate character segmentation, which dramatically reduces the amount of calculation and improves the efficiency.

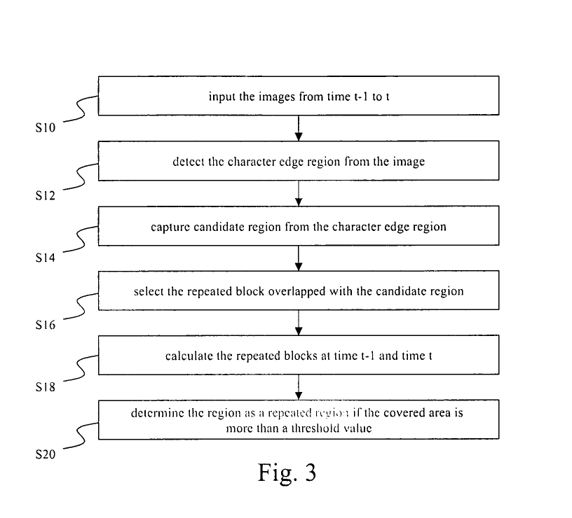

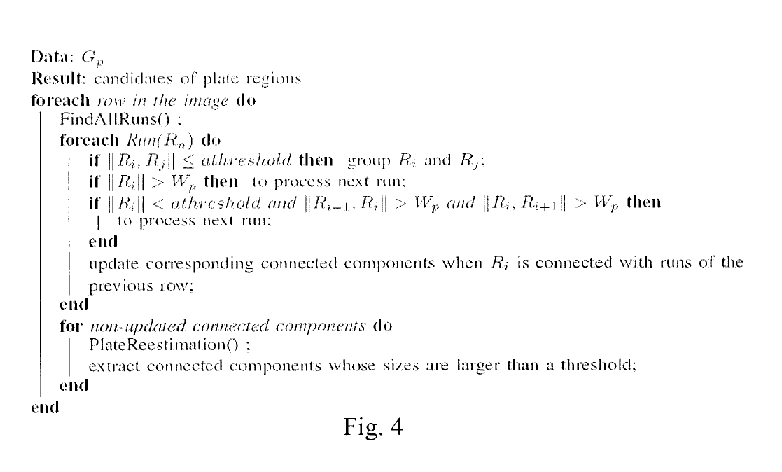

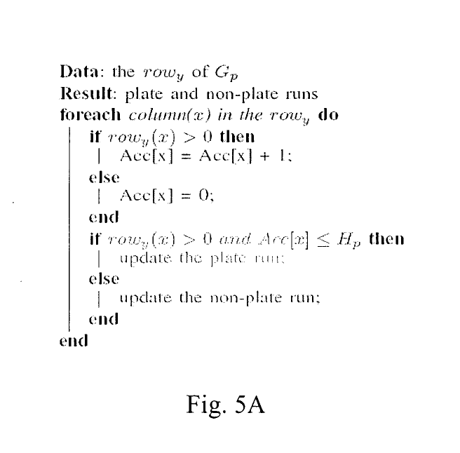

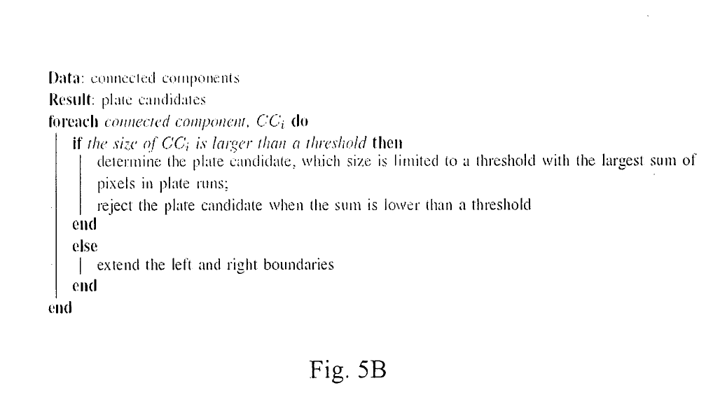

The license plate recognition method in the present invention includes two parts: (1) spatial feature: applying the Bi-level one-pass plate extraction algorithm to extract the candidate region rapidly; and (2) temporal feature: detecting the repeated region and rejecting the candidate region. Please refer to FIG. 3. FIG. 3 is a flowchart showing an embodiment of operations of the license plate recognition system. The images (i.e. the images from time t−1 to t) are captured by an image capture device, as shown in step S10. Next, step S12 and step S14 show the first part of spatial feature in the present invention. In step S12, the system generates the character edge region by calculating and comparing the vertical gradient of the original inputted image and a threshold value (e.g. the threshold value can be defined as the value of Otsu algorism multiple a coefficient). If the vertical gradient of a pixel in the original image is larger than the threshold value, that pixel is regarded as a character edge pixel. In step S14, the Bi-level one-pass plate extraction (BOPE) algorithm is utilized to generate the candidate regions. Assume that Wp and Hp represent the width and the height of the candidate region, respectively. Np represents the number of plate characters. All middle pixels between the detected character edge pixels in the character edge region Gp are regarded as edge pixels if the horizontal distance between the detected character edge pixels is less than a threshold value (the threshold value can be defined as Wp/Np, which represents the largest distance between the character edges on the same plate). The adjacent character edge pixels in Gp are regarded as a “plate run”, and the adjacent non-character edge pixels in Gp are regarded as a “non-plate run”. The system will remove the “plate run” if it satisfies one of the following conditions: (1) the vertical height is larger than Hp; (2) the horizontal length is larger than Wp; and (3) the “plate run” is located between two other plate runs of which both lengths are larger than Wp. FIGS. 4, 5A, and 5B are diagrams schematically showing the algorithm of Bi-level one-pass plate extraction (BOPE) in the present invention. By utilizing BOPE algorithm, the present invention can avoid spending much time on calculation of the candidate regions.

Step S16 to step S20 show the second part of temporal feature in the present invention: detecting the repeated region and rejecting the candidate region. If the captured scene in the image is still, which means the consecutive images have similar appearances, that is, the candidate regions will have the same or similar classification results. Thus, discarding the repeated regions can avoid redundant calculation and save significantly amount of loading and time. In the present invention, a block match scheme is proposed to calculate the similarity among the inputted images. The similarity can be calculated by the “tangent distance” measure. First, each image is tessellated into blocks with 16×16 dimensions for further comparisons. In step S16, the blocks overlapping with the candidate regions are selected and the system calculates the similarity of blocks in the image at time t−1 and the image at time t. As shown in step S18, the blocks with the distance values lower than a threshold value are regarded as repeated blocks. In step S20, the system discards the overlapped candidate regions, which are overlapped with the repeated regions and the covered area more than a pre-defined percentage. That is, if the pre-defined percentage is 60%, then the system will discard the candidate region with the covered area over 60%.

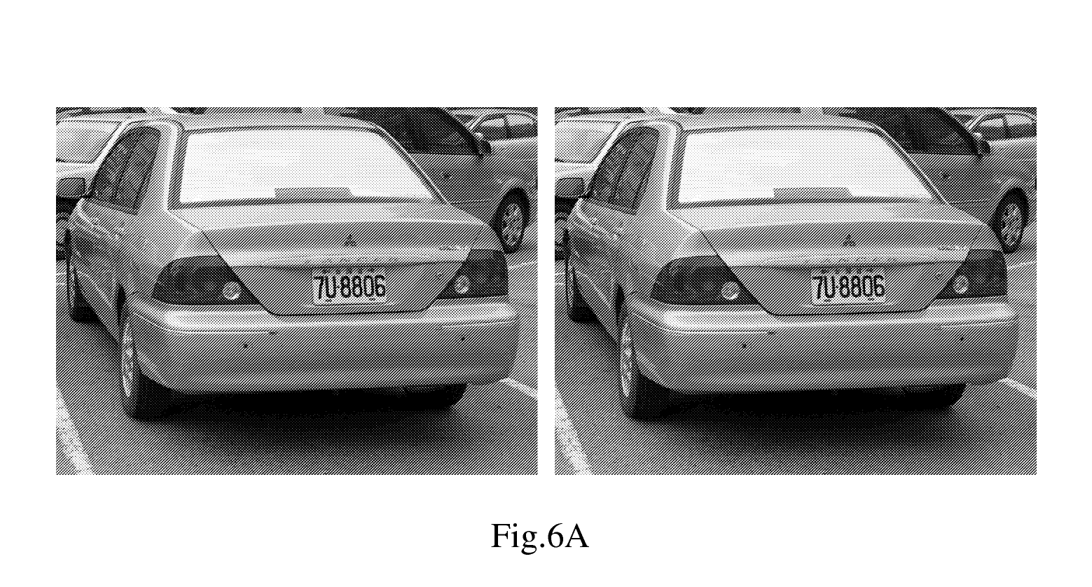

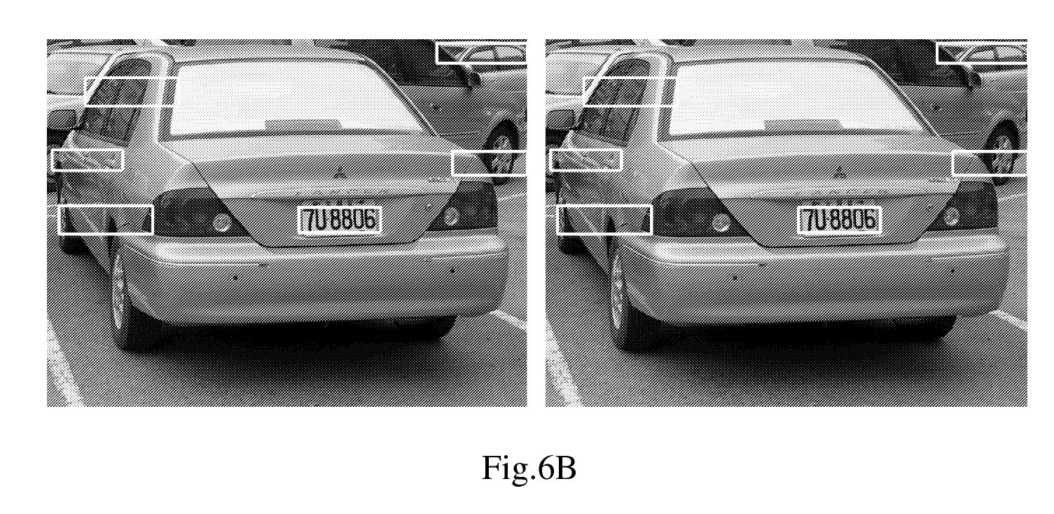

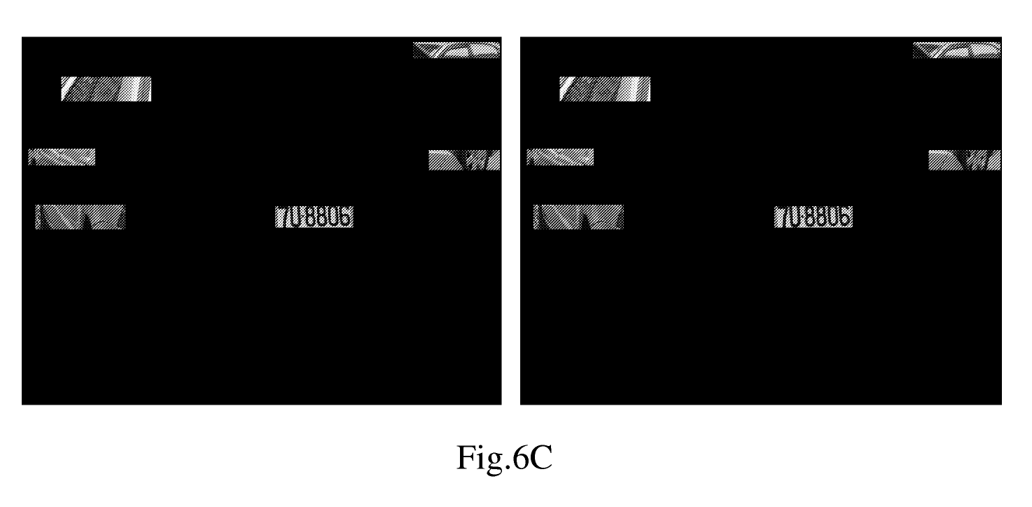

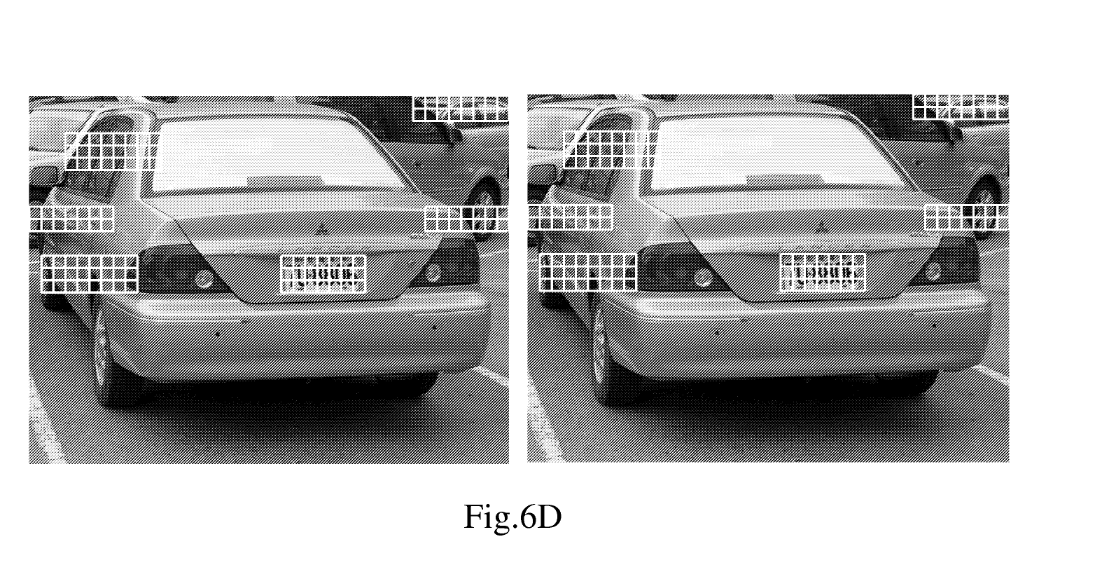

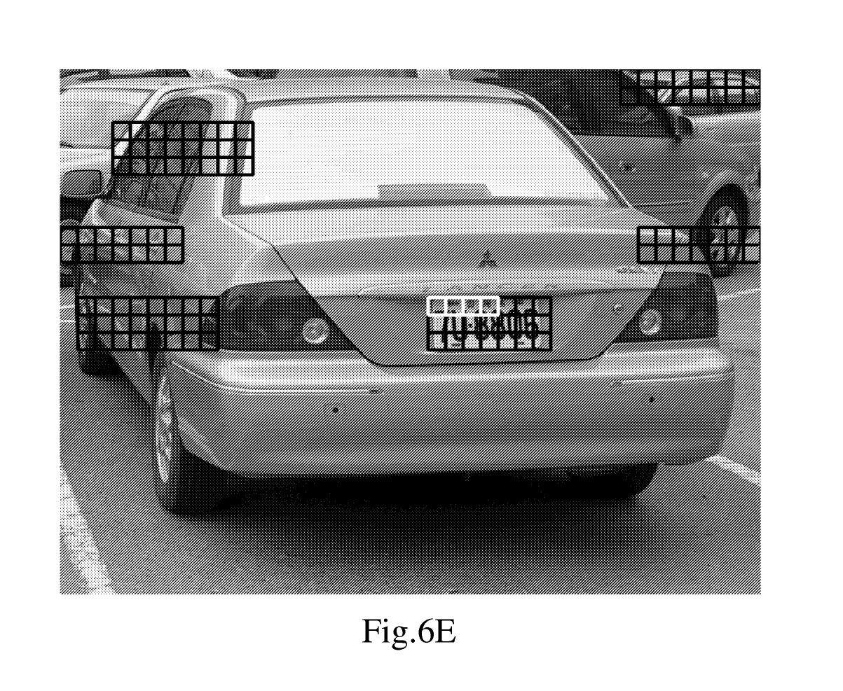

FIGS. 6A to 6E are diagrams schematically showing an embodiment of the license plate recognition system according to the present invention. From FIGS. 6A to 6D, the left side indicates the images captured at time t−1; and the right side indicates the images captured at time t. First, as shown in FIG. 6A, the system captures the image at time t−1 and the image at time t. Then the system extracts a plurality of candidate regions according to the BOPE algorithm, as shown in the frame of FIG. 6B. Next, in FIG. 6C, the regions overlapped by candidate regions are regarded as required detecting repeated regions, and the rest of non-required detecting regions are blocked by shadow. The system then detects the required detecting repeated blocks from those required detecting repeated regions, as shown in the blocks of FIG. 6D. Next, the system calculates the similarity of the blocks in FIG. 6D by selecting the repeated blocks with the distance values lower than a threshold value, as shown in the blocks of FIG. 6E. The dark blocks represent the repeated blocks, and the white blocks represent the non-repeated blocks. Lastly, the system discards the repeated candidate regions which are overlapped with the repeated regions and the covered area more than a pre-defined percentage.

In FIGS. 6A to 6E, the image has 113 blocks regarded as the required detecting repeated blocks, and within these 113 blocks, 109 blocks are detected as repeated blocks. Therefore, all candidate regions extracted by the BOPE algorithm in the image at time t will be discarded because all of them are repeated candidate regions. In fact, the real plate character region has been acquired by the preceding image.

The plate recognition system utilizes the candidate regions in each inputted image to detect the repeated regions. Therefore, when the candidate region is overlapped, the system can use the same block to perform the detecting function without recalculating the similarity of the block. For example, with respect to license plate detecting applications, the related art may need to detect different plates with different sizes, and generate multiple candidate regions in the same image position. In the present invention, the plate recognition system can only calculate the repeated block once to determine a plurality of candidate regions, which dramatically reduces the amount of calculation.

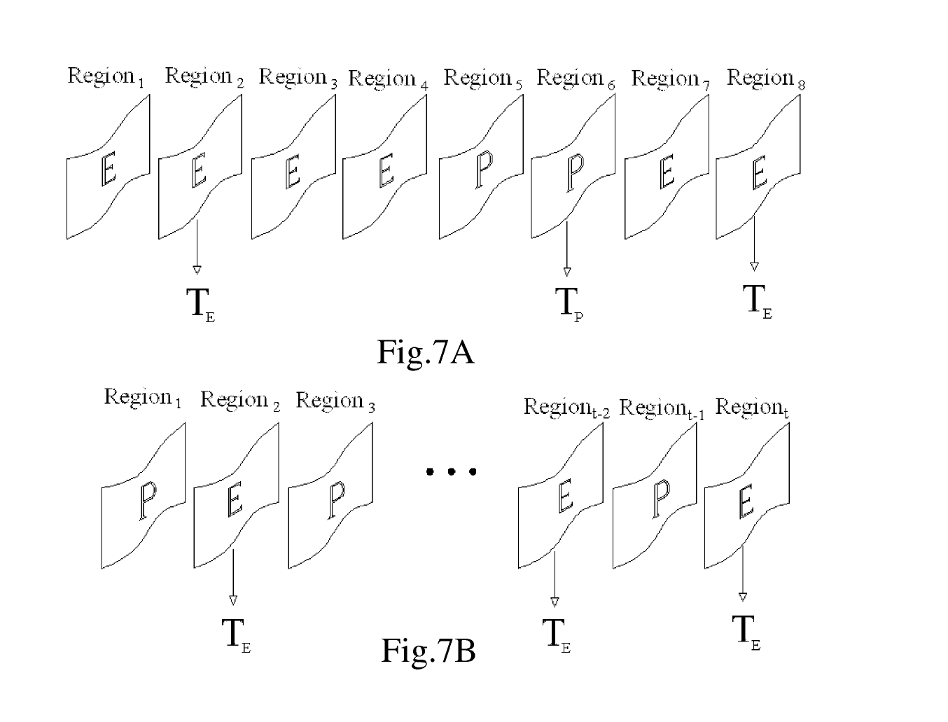

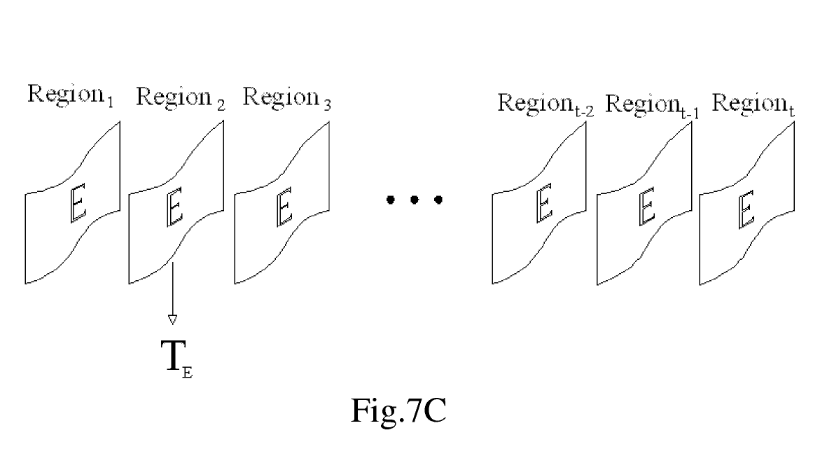

Usually the plate recognition system is required to compute the related features in the image while calculating the similarity of the candidate blocks. For example, the system needs to calculate the tangent vectors of the inputted image while the tangent distance measure is adopted. More tangent vector calculations would cause more loading for the system. Therefore, in the present invention, the plate recognition system adopts one side image feature measure to compute the similarity, such as one side tangent distance measure. That is, in the present invention, the system only extracts the feature from the following block when the system detects the preceding block as a non-repeated block. On the contrary, when the system detects the preceding block as a repeated block, the preceding block and feature can be retained for the following similarity calculation. As shown in FIG. 7A, with respected to two different inputted picture P and picture E, since the first picture is non-repeated picture, the system performs the feature extraction (T_{E}) to the second picture. Similarly, since the fifth and seventh pictures are non-repeated picture, the system performs the feature extractions (T_{P} and T_{E}) to the sixth and eighth pictures respectively. With respected to FIG. 7B, the system calculates the tangent vector once for each two pictures, which reduces 50% amount of calculation. As shown in FIG. 7C as the best embodiment, since the pictures E appear continuously, the system requires only one feature extraction.

As mentioned above, the license plate recognition method in the present invention first spatially selects the detecting regions, and then compares the regions of different images at different time. Therefore, the system can avoid redundant calculation if there are similar regions, and significantly improves the efficiency and performance for recognizing the images of license plates.

Those described above are only the preferred embodiments to exemplify the present invention but not to limit the scope of the present invention. Any equivalent modification or variation according to the shapes, structures, features and spirit disclosed in the specification is to be also included within the scope of the present invention.

What is claimed is:

1. A license plate recognition method by utilizing spatial-temporal search-space reduction, said method comprising:
(a) capturing a plurality of candidate regions from an inputted image, and placing said candidate regions in a candidate area;
(b) detecting whether said candidate regions of a current image has been appeared on at least a preceding image, if yes, then discarding said candidate regions from said candidate area; and
(c) outputting said candidate regions from said candidate area.

2. The license plate recognition method of claim 1, wherein said step (a) further comprises:
capturing a plurality of said candidate regions from a image.

3. The license plate recognition method of claim 1, wherein said step (b) further comprises:
comparing a similarity of said candidate regions based on different timing.

4. The license plate recognition method of claim 1, wherein said step (b) further comprises:
comparing said similarity of said candidate regions by separating said inputted image into a plurality of blocks, and making an image distance comparison with said blocks which overlapping with said candidate regions.

5. The license plate recognition method of claim 4, wherein said blocks is defined as a repeated block if said image distance is less than a threshold value, and said candidate region is defined as a repeated region based on an overlapping degree between said repeated block and said candidate regions.

6. The license plate recognition method of claim 4, wherein said image distance is got from one-side tangent distance of said image.

7. The license plate recognition method of claim 4, wherein if said blocks of said candidate regions has been defined as a non-repeated block previously, extract feature of said blocks.

8. The license plate recognition method of claim 1, wherein each candidate region is calculated and transformed to a character edge region according to vertical gradient, and then acquires a plurality of plate character candidate regions according to a bi-level one-pass plate extraction (BOPE) algorithm.

9. The license plate recognition method of claim 8, wherein said plate character candidate regions are defined as regions that bound top and bottom of plate characters tightly.

10. The license plate recognition method of claim 8, wherein said plate character candidate region has a predetermined height and a predetermined width, and if a height of said plate character candidate region is greater than said predetermined height or the width of said plate character candidate region is greater than said predetermined width, reducing said plate character candidate region in order to conform to said predetermined height and width.

11. The license plate recognition method of claim 1, wherein said step (a) is performed by a character edge detecting module and a plate character candidate region detecting module.

12. The license plate recognition method of claim 1, wherein said step (b) is performed by a repeated region detecting module.

13. The license plate recognition method of claim 1, wherein said inputted image is captured by an image captured device.

14. A license plate recognition system by utilizing spatial-temporal search-space reduction, said device comprising:
a character edge region detecting module for selecting a pixel with character edge feature from an inputted image;
a plate character candidate region detecting module for selecting a plurality of candidate regions from said pixel, and if said candidate regions comprise at least a plate character, said candidate regions is defined as a region that bound top and bottom of said plate characters tightly; and
a repeated region detecting module for detecting if said candidate regions of said inputted image has been appeared in a preceding image.

15. The license plate recognition system of claim 14, wherein each candidate region is calculated from character edge regions according to vertical gradient, and then acquires a plurality of plate character candidate regions according to a bi-level one-pass plate extraction (BOPE) algorithm.

16. The license plate recognition system of claim 14, wherein said repeated region detecting module separates said candidate regions into a plurality of blocks, calculates said repeated block based on a current image and a preceding image, and determines whether said candidate region is repeated according to said repeated block.

17. The license plate recognition system of claim 14, wherein said repeated region detecting module further compares a similarity of said candidate regions by separating said image into a plurality of blocks, and making an image distance comparison with said blocks said blocks which overlapping with said candidate regions.

18. The license plate recognition system of claim 17, wherein said block is defined as a repeated block if said image distance is less than a threshold value, and said candidate region is defined as a repeated region based on an overlapping degree between said repeated block and said candidate regions.

19. The license plate recognition system of claim 17, wherein said image distance is got from one-side tangent distance of said inputted image.
